(19) United States
(12) Patent Application Publication
(10) Pub. No.: US 2010/0233341 A1
(43) Pub. Date: Sep. 16, 2010

(54) MASKING AGENT FOR OXIDIZED POLYUNSATURATED FATTY ACIDS

(75) Inventor: Roland C. Abate, JR., Hawthorne, NJ (US)

Correspondence Address: Stephen B. Salai, Esq.;Harter Secrest & Emery LLP, 1600 Bausch & Lomb Place, Rochester, NY, 14604-2711, US

(73) Assignee: WYNN STARR FLAVORS, INC., Allendale, NJ (US)

(21) Appl. No.: 12/403,847

(22) Filed: Mar. 13, 2009

(51) Int. Cl. A23L 1/226; A23D 9/007

(52) U.S. Cl. 426/538

(57) ABSTRACT

The present invention describes a masking agent for food products containing polyunsaturated fatty acids. That masking agent masks the rancid notes resulting from peroxide generated by the oxidation of the polyunsaturated fatty acids, without imparting any flavors to the food products.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present invention relates to masking agents for food products and more particularly, to masking agents for oxidized polyunsaturated fatty acids, such as omega-3 fatty acids.

2. Description of Related Art

Recent studies suggest that the consumption of omega-3 fatty acids provides certain health benefits. For example, omega-3 fatty acids have been shown, among other things, to reduce an individual's level of triglycerides, increase high-density cholesterol (HDC), often referred to as the “good cholesterol,” and decrease blood pressure, all of which reduces the risk of heart disease. Omega-3 fatty acids have also been found to provide anti-inflammatory effects that improve the prognosis of certain chronic inflammatory diseases, such as atherosclerosis, psoriasis, systemic lupus erythematosus, rheumatoid arthritis, and inflammatory bowel disease.

Omega-3 fatty acids are polyunsaturated fatty acids with carbon-carbon double bonds, the first of which is positioned at the third carbon bond from the methyl end of the fatty acid. Alpha linolenic acid (ALA), eicosapentaenoic acid (EPA) and docosahexaenoic acid (DHA) are three omega-3 fatty acids that are “essential” nutrients for humans because they are not manufactured by the body and must be obtained through ingestion.

Fish oil and certain vegetable oils are rich in omega-3 fatty acids. However, most individuals do not consume enough fish and vegetable oils to reach the recommended levels of omega-3 fatty acids in their diet. Therefore, food scientists add omega-3 fatty acids to certain foods so that individuals can receive the known health benefits. In fact, research shows that the market for omega-3 enriched foods is projected to reach $7 billion in sales by 2011. Food scientists, for example, have added omega-3 fatty acids to several types of food products such as cereals, orange juice, pasta, butter substitutes, eggs, cooking oils, and dairy products.

A problem with fortifying food products with omega-3 fatty acids, however, is that omega-3 fatty acids are highly susceptible to oxidation, which produces peroxide and other oxidation byproducts. Omega-3 fatty acids are readily oxidized upon exposure to light and warm temperatures. In fact, merely exposing omega-3 fatty acids to a room temperature environment promotes oxidation. Further, oxidation of omega-3 fatty acids simply occurs over time. The oxidation products are thought to provide the numerous health benefits to individuals, however, the peroxide generated imparts a fishy odor and rancid flavor to the food, which is easily detected by consumers. Thus, before the food has actually expired, the food is odiferous and develops an undesirable taste.

To mask the peroxide produced by the oxidation of the omega-3 fatty acids in food products, food scientists have tried adding an extremely sweet flavor, such as chocolate, vanilla, or strawberry. These ingredients, when used alone to mask the odor and flavor imparted by the oxidation of the omega-3 fatty acids, need to be used in amounts that flavor the food product. Since the flavor is detectable by consumers, the product must be labeled as “flavored.”

It is therefore desirable to mask the unpleasant odor and flavor of the peroxide generated by the oxidation of omega-3 fatty acids added to food products, without imparting additional flavors to the food products, which then requires the food to be labeled as “flavored.”

### BRIEF SUMMARY OF THE INVENTION

A masking agent for food products containing oxidized polyunsaturated fatty acids which may contain a carrier, vanillin, and flavoring agents sufficient to provide both creamy and sweet notes has been surprisingly discovered. This has been achieved by incorporating vanillin and flavoring agents, such as maltol, heliotropin and cyclotene, into a carrier. The carrier may be propylene glycol or medium chain triglycerides. Preferably, the ratio of vanillin to maltol to heliotropin to cyclotene is 100:2:5:2. The masking agent masks the rancid flavor and odor of the oxidized polyunsaturated fatty acids undetectable, while not imparting a flavor to the food product.

### BRIEF DESCRIPTION OF THE SEVERAL VIEWS OF THE DRAWING(S)

None.

### DETAILED DESCRIPTION OF THE INVENTION

The present invention includes compositions for taste masking oxidized polyunsaturated fatty acids in food products without imparting a particular flavor to the food product. The masking agent comprises an admixture of a carrier, vanillin, and flavoring agents sufficient to provide both creamy and sweet notes. In particular, it has been found that an effective taste masking agent for a food product containing oxidized polyunsaturated fatty acids, such as omega-3 fatty acids, is produced from an admixture of about 99.9074% to 99.8746% by weight of a carrier, 0.0850% to 0.1150% by weight of vanillin, 0.0017% to 0.0023% by weight of maltol, 0.0042% to 0.0058% by weight of heliotropin and about 0.0017% to 0.0023% by weight of cyclotene. The weights listed are in percent of the total composition.

More preferably, the masking agent is produced from an admixture of about 99.8801% to 99.9019% by weight of a carrier, about 0.1100% to 0.900% by weight of vanillin, about 0.0022% to 0.0018% by weight of maltol, about 0.0055% to 0.0045% heliotropin and about 0.0022% to 0.0018% by weight cyclotene.

Most preferably, an effective taste masking agent for a food product containing oxidized polyunsaturated fatty acids, such as omega-3 fatty acids, is produced from an admixture of about 99.891% by weight of a carrier, 0.100% by weight of vanillin, 0.002% by weight maltol, 0.005% by weight heliptropin, and 0.002% by weight cyclotene.

Surprisingly, we have found that the masking agent compositions masks the rancid flavor produced by the oxidation of polyunsaturated fatty acids, such as omega-3 fatty acids, without flavoring the food product. The masking agent also prolongs the shelf-life of food products because the peroxide generated over time cannot be tasted by consumers. It should be appreciated by those having ordinary skill in the art that the vanillin and creamy, sweet note flavoring agents can be natural or synthetic ingredients. By “note,” it is meant a detectable characteristic.

As a taste masking agent, the composition is employed at a use level in an amount in the range of 0.10% to 2%, preferably in the range of 0.10% to 1% and most preferably in the range of 0.10% to 0.40% by weight of the food product to which it is applied as a taste masking agent. At these levels, the masking agent serves the function of masking the rancid flavor and odor, or “off notes,” of the peroxide, without imparting flavor to the food product.

The ratio of vanillin to maltol to heliotropin to cyclotene is important for masking the flavor of the peroxide caused by the oxidation of the polyunsaturated fatty acids, without imparting flavor to the food product. A ratio of about 100:2:5:2 is most preferable.

The carrier is selected according to the desired food product. Preferably, propylene glycol is used as the carrier to provide a water-soluble masking agent. For an oil-soluble masking agent, medium chain triglycerides, such as Neobee® MCTs, available from Stephan Food & Health Specialties in Maywood, N.J., can be used as the carrier.

The food product can be any liquid food product, including, but not limited to, soda, juices, water, protein shakes, dairy products, such as non-fat milk, 2% milk, whole milk, cheese, and yoghurt, and, cooking oils, such as vegetable oil, canola oil, olive oil, corn oil, sunflower oil, grape seed oil, flaxseed oil, and peanut oil. The food product can also be butter or margarine. Most preferably, the food product is non-fat milk with propylene glycol used as the carrier in the masking agent, or canola oil, with Neobee® used as the carrier in the masking agent.

The present invention is further illustrated by the following examples. All parts and percentages in the examples and throughout the specification and claims are by total weight of the composition unless otherwise indicated.

### EXAMPLE 1

The masking agent is prepared by admixing:

| No. | Ingredient | Percent (w/w) |
|---|---|---|
| 1. | Natural Vanillin | 7.14 |
| 2. | Natural Maltol | 0.16 |
| 3. | Natural Heliotropin | 0.35 |
| 4. | Natural Cyclotene | 0.16 |
| 5. | Propylene Glycol | 92.19 |

Procedure

Approximately 0.1 weight percent of the masking agent is added to 10 week old, rancid non-fat milk containing omega-3 fatty acids. A trained taster compares samples of the 10 week old, rancid non-fat milk having the masking agent to control samples of the 10 week old, rancid non-fat milk not having the masking agent and to control samples of fresh non-fat milk without omega-3 fatty acid. The trained taste taster ascertains whether or not there are differences in the flavor of the samples to be tested compared to the controls. The trained taster characterizes the various flavor notes as set forth in Table I.

### EXAMPLE 2

The masking agent is prepared by admixing:

| No. | Ingredient | Percent (w/w) |
|---|---|---|
| 1. | Natural Vanillin | 3.57 |
| 2. | Natural Maltol | 0.10 |
| 3. | Natural Heliotropin | 0.20 |
| 4. | Natural Cyclotene | 0.10 |
| 5. | Propylene Glycol | 96.03 |

Procedure

The procedure of Example 1 is followed and then the trained taste taster ascertains whether or not differences exist in the flavor of the samples to be tested compared to the controls. The trained taster characterizes the various flavor notes set out in Table I.

### EXAMPLE 3

The masking agent is prepared by admixing:

| No. | Ingredient | Percent (w/w) |
|---|---|---|
| 1. | Natural Vanillin | 1.00 |
| 2. | Natural Maltol | 0.01 |
| 3. | Natural Heliotropin | 0.01 |
| 4. | Natural Cyclotene | 0.01 |
| 5. | Propylene Glycol | 98.975 |

Procedure

The procedure of Example 1 is followed and then the trained taste taster ascertains whether or not differences exist in the flavor of the samples to be tested compared to the controls. The trained taster characterizes the various flavor notes set out in Table I.

### EXAMPLE 4

The masking agent is prepared by admixing:

| No. | Ingredient | Percent (w/w) |
|---|---|---|
| 1. | Natural Vanillin | 0.015 |
| 2. | Natural Maltol | 0.002 |
| 3. | Natural Heliotropin | 0.005 |
| 4. | Natural Cyclotene | 0.002 |
| 5. | Propylene Glycol | 99.841 |

Procedure

The procedure of Example 1 is followed. The trained taste taster ascertains whether or not differences exist in the flavor of the samples to be tested compared to the controls. The trained taster characterizes the various flavor notes set out in Table I.

### EXAMPLE 5

The masking agent is prepared by admixing:

| No. | Ingredient | Percent (w/w) |
|---|---|---|
| 1. | Natural Vanillin | 0.100 |
| 2. | Natural Maltol | 0.002 |
| 3. | Natural Heliotropin | 0.005 |
| 4. | Natural Cyclotene | 0.002 |
| 5. | Propylene Glycol | 99.891 |

Procedure

The procedure of Example 1 is followed and then the trained taste taster ascertains whether or not differences exist in the flavor of the samples to be tested compared to the controls. The trained taster characterizes the various flavor notes set out in Table I.

### EXAMPLE 6

The masking agent is prepared by admixing:

| No. | Ingredient | Percent (w/w) |
|---|---|---|
| 1. | Natural Vanillin | 0.075 |
| 2. | Natural Maltol | 0.002 |
| 3. | Natural Heliotropin | 0.005 |
| 4. | Natural Cyclotene | 0.002 |
| 5. | Propylene Glycol | 99.916 |

Procedure

The procedure of Example 1 is followed. The trained taste taster ascertains whether or not differences exist in the flavor of the samples to be tested compared to the controls. The trained taster characterizes the various flavor notes set out in Table I.

The trained taster characterizes the various flavor and off notes of the compositions set forth in Examples 1-6 above as follows:

TABLE I
Non-Fat Milk Experiment

| Example | Characterization of the flavor | Description of the “Off |
|---|---|---|
| No. | notes | Notes” |
| 1 | Sweet, creamy and vanilla notes | Off notes not detectible |
| 2 | Sweet, creamy and vanilla notes | Off notes not detectible |
| 3 | Sweet, creamy and vanilla notes | Off notes not detectible |
| 4 | No detectible notes | Off notes detectible |
| 5 | No detectible notes | Off notes not detectible |
| 6 | No detectible notes | Off notes detectible |

The results clearly indicate that the compositions of Examples 1-3 are not acceptable because, even though the off notes are no longer detectable, the sweet, creamy and vanilla flavor notes are detectable in the milk. A masking agent that can be detected by consumers is not acceptable because milk containing such a masking agent must be labeled as “flavored” and because many customers prefer milk without a sweet, creamy and/or vanilla flavor. The results also show that the composition of Examples 4 and 6 are not acceptable because the masking agent, although not detectable, is not capable of masking the off notes produced by the oxidation of the omega-3 fatty acids. The results clearly indicate, however, that the composition of Example 5 is preferred because the masking agent masks the off notes created by the oxidation of the omega-3 fatty acids without imparting sweet, creamy and/or vanilla flavor notes to the milk.

Various use levels of the masking agent composition of Example 5 are tested in canola oil containing omega-3 fatty acids as set forth in the examples below. Instead of propylene glycol, Neobee® is used as the carrier to provide an oil soluble masking agent.

### EXAMPLE 7

The masking agent is prepared by admixing:

| No. | Ingredient | Percent (w/w) |
|---|---|---|
| 1. | Natural Vanillin | 0.100 |
| 2. | Natural Maltol | 0.002 |
| 3. | Natural Heliotropin | 0.005 |
| 4. | Natural Cyclotene | 0.002 |
| 5. | Neobee ® | 99.891 |

Procedure

Approximately 0.1 weight percent of the masking agent is added to 10 week old canola oil containing omega-3 fatty acids. A trained taster compares samples of the 10 week old canola oil having the masking agent to control samples of the 10 week old canola oil not having the masking agent and to samples of fresh canola oil without the omega-3 fatty acid. The trained taste taster ascertains whether or not differences in the flavor of the samples to be tested as compared with the controls exist. The trained taster characterizes the various flavor notes set forth in Table II.

### EXAMPLE 8

The procedure of Example 7 is followed, except approximately 0.3 weight percent of the masking agent set forth in Example 7 is added to 10 week old canola oil containing omega-3 fatty acid and compared to the control samples. The trained taster describes and characterizes the various flavor notes set out in Table II.

### EXAMPLE 9

The procedure of Example 7 is followed, except approximately 0.4 weight percent of the masking agent set forth in Example 7 is added to 10 week old canola oil containing omega-3 fatty acid and compared to the control samples. The trained taster describes and characterizes the various flavor notes set out in Table II.

### EXAMPLE 10

The procedure of Example 7 is followed, except approximately 0.5 weight percent of the masking agent set forth in Example 7 is added to 10 week old canola oil containing omega-3 fatty acid and compared to control samples.

The trained taster describes and characterizes the various flavor and off notes as follows:

TABLE II
Canola Oil Experiment

| Example | Characterization of the flavor | Description of the “Off |
|---|---|---|
| No. | notes | Notes” |
| 7 | No detectible notes | Off notes detectible |
| 8 | No detectible notes | Off notes detectible |
| 9 | No detectible notes | Off notes not detectible |
| 10 | Sweet, creamy and vanilla notes | Off notes not detectible |

The masking agent of Example 7 added to canola oil at approximately 0.1 weight percent and at approximately 0.3 weight percent, as set forth in Examples 7 and 8, respectively, do not effectively mask the off-notes generated by the oxidation of the omega-3 fatty acids in the canola oil. Therefore, these use levels are not preferable. The use level of approximately 0.5, set forth in Example 10, is also not preferable because sweet, creamy and vanilla flavor notes are detectable. Clearly, the use level of the masking agent in canola oil of approximately 0.4 weight percent, as set forth in Example 9, is most preferable because neither the sweet, creamy, and/or vanilla flavor notes, nor the off notes are detectable in the food product.

The masking agent is further tested for effectiveness after the packaging process. Specifically, the masking agent composition of Example 5 is added to non-fat, unpasteurized milk that is then UHT (ultra high temperature) processed and packaged. The milk containing the masking agent is then tested according to the following procedure.

Approximately 0.1 weight percent of the masking agent of Example 5 is mixed well into non-fat milk containing omega-3 fatty acids. The non-fat milk is UHT processed for 1-2 seconds at a temperature of at least 275 degrees Fahrenheit (135 degrees Celsius). The non-fat milk is cooled and packaged into half-gallon tetrapack containers. Samples of the cooled non-fat milk having the masking agent are compared to samples of the cooled non-fat milk not having the masking agent by trained taste testers. The trained taste testers identify and describe any flavor modifications noted. The masking agent is not detected by the trained tasters in the samples containing the masking agent when compared to the control samples. In addition, the “cooked notes” associated with the UHT processing are not detected by the trained tasters in the samples containing the masking agent. “Cooked notes” are temporary notes detected by trained tasters resulting from the UHT process.

Indeed, the masking agent described above provides numerous advantages. In particular, we have found that the masking agent covers up the rancid flavor produced by the oxidation of omega-3 fatty acids, without flavoring the milk. We also found that the masking agent prolongs the shelf-life of food products because the peroxide cannot be tasted by consumers.

This invention being thus described, it will be obvious that the same may be varied in many ways. Such variations are not to be regarded as a departure from the spirit and scope of the invention and all such modifications are intended to be included within the scope of the following claims.

1. A composition for masking the flavor of peroxide derived from the addition of polyunsaturated fatty acids to food products, the composition comprising:
a carrier;
vanillin; and
flavoring agents sufficient to provide both creamy and sweet notes.

2. The composition of claim 1, wherein the flavoring agents sufficient to provide both creamy and sweet notes are selected from a group consisting of natural maltol, natural heliotropin and natural cyclotene.

3. The composition of claim 1, wherein the ratio of vanillin to the flavoring agents sufficient to provide both creamy and sweet notes is 100:9, respectively.

4. The composition of claim 1, wherein the flavoring agents sufficient to provide both creamy and sweet notes are maltol, heliotropin and cyclotene.

5. The composition of claim 4, wherein the ratio of maltol to heliotropin to cyclotene is about 2:5:2, respectively.

6. The composition of claim 4, wherein the ratio of vanillin to maltol to heliotropin to cyclotene is about 100:2:5:2, respectively.

7. The composition of claim 4, wherein the carrier is present by weight in the amount of between about 99.9074% and 99.8746%, wherein the vanillin is present by weight in the amount of between about 0.085% and 0.115%, wherein the maltol is present by weight in the amount of between about 0.0017% and 0.0023%, wherein the heliotropin is present by weight in the amount of between about 0.0042% and 0.0058%, and wherein the cyclotene is present by weight in the amount of between about 0.0017% and 0.0023%.

8. The composition of claim 4, wherein the carrier is present by weight in the amount of about 99.891%, wherein the vanillin is present by weight in the amount of about 0.100%, wherein the maltol is present by weight in the amount of about 0.002%, wherein the heliotropin is present by weight in the amount of about 0.005%, and wherein the cyclotene is present by weight in the amount of about 0.002%.

9. The composition of claim 1, wherein the oxidized polyunsaturated fatty acids are omega-3 fatty acids.

10. The composition of claim 1, wherein the food product is a dairy product.

11. The composition of claim 10, wherein the dairy product is fat-free milk.

12. The composition of claim 11, wherein the dairy product is UHT processed.

13. The composition of claim 1, wherein the food product is cooking oil.

14. The composition of claim 1, wherein the food product is canola oil.

15. A masking agent for food products containing oxidized polyunsaturated fatty acids comprising:
a carrier;
vanillin;
maltol;
heliotropin; and
cyclotene.

16. The masking agent of claim 15, wherein the carrier is propylene glycol.

17. The masking agent of claim 15, wherein the carrier is medium chain triglycerides.

18. The masking agent of claim 15, wherein the ratio of vanillin to maltol to heliotropin to cyclotene is about 100:2:5:2, respectively.

19. The masking agent of claim 15, wherein the ratio of maltol to heliotropin to cyclotene is about 2:5:2, respectively.

20. The masking agent of claim 15, wherein the carrier is present by weight in the amount of between about 99.8801% and 99.9019%, wherein the vanillin is present by weight in the amount of between about 0.1100% and 0.0900%, wherein the maltol is present by weight in the amount of between about 0.0022% and 0.0018%, wherein the natural heliotropin is present by weight in the amount of between about 0.0055% and 0.0045%, and wherein the cyclotene is present by weight in the amount of between about 0.0022% and 0.0018%.

21. The masking agent of claim 15, wherein the carrier is present by weight in the amount of between about 99.9074% and 99.8746%, wherein the vanillin is present by weight in the amount of between about 0.0850% and 0.1150%, wherein the maltol is present by weight in the amount of between about 0.0017% and 0.0023%, wherein the heliotropin is present by weight in the amount of between about 0.0042% and 0.0058%, and wherein the cyclotene is present by weight in the amount of between about 0.0017% and 0.0023%.

22. The masking agent of claim 15, wherein the carrier is present by weight in the amount of about 99.891%, wherein the vanillin is present by weight in the amount of about 0.100%, wherein the maltol is present by weight in the amount of about 0.002%, wherein the heliotropin is present by weight in the amount of about 0.005%, and wherein the cyclotene is present by weight in the amount of about 0.002%.

23. The masking agent of claim 15, wherein the oxidized polyunsaturated fatty acids are omega-3 fatty acids.

24. The masking agent of claim 15, wherein the food product is fat-free milk.

25. The masking agent of claim 15, wherein the food product is cooking oil.

26. The masking agent of claim 15, wherein the food product is canola oil.
